(19) United States
(12) Patent Application Publication
(10) Pub. No.: US 2008/0260993 A1
(43) Pub. Date: Oct. 23, 2008

(54) Moisture drainage product having limited bearing surface, wall system incorporating such and method therefore

(75) Inventor: John H. Koester, St. Michael, MN (US)

Correspondence Address: IPLM GROUP, P.A., POST OFFICE BOX 18455, MINNEAPOLIS, MN, 55418, US

(73) Assignee: Masonry Technology Incorporated

(21) Appl. No.: 12/148,298

(22) Filed: Apr. 17, 2008

Related U.S. Application Data
(60) Provisional application No. 60/912,530, filed on Apr. 18, 2007.

(51) Int. Cl. B32B 3/10; E04F 13/072; E04B 1/70

(52) U.S. Cl. 428/131; 156/71; 52/302.1

(57) ABSTRACT

A moisture drainage product and a wall system utilizing such product adapted to allow drainage of moisture from a wall of a structure and a method of draining moisture from a wall structure. A sheet of material forms a plurality of ridges and grooves on opposite sides of the sheet of material. The plurality of ridges and grooves forms a moisture drainage product having a bearing surface of not more than twenty (20%) of the surface area of the product. A sheet of water permeable material is affixed to one side of the sheet of material.

### RELATED APPLICATION

This application claims priority to provisional U.S. application Ser. No. 60/912,530, filed Apr. 18, 2007.

### FIELD

This invention relates to moisture drainage products and, more particularly, to moisture drainage products intended for incorporation in wall systems and methods for providing moisture drainage in wall systems.

### BACKGROUND

Warm, moisture-laden air can exist in nearly many different buildings in many locations. Even in buildings in relatively cold, dry climates may contain a significant amount of moisture arising, for example, through common household activities, such as cooking, bathing and showering.

Especially in colder climates, insulation in a wall structure helps to reduce heat loss from buildings. As moisture-laden air passes through the wall structure of such buildings, the moisture-laden air encounters steadily decreasing temperatures. As the air is cooled while moving from the interior of a wall structure to the exterior of the wall structure, the air may reach its dew point, resulting in the water vapor in the air condensing to form water droplets. The result may be a buildup of moisture in the wall structure.

Vapor barriers are commonly employed on the warm side of wall structures in order to prevent moisture-laden air from entering the wall structure. However, vapor barriers are commonly not perfect. In a typical building, multiple penetrations of a vapor barrier can occur, e.g., from electrical and plumbing lines and from windows and doors, as well as inadvertent punctures of the barrier.

If the exterior temperature is cold enough, the moisture existing in the wall structure could eventually turn to frost or ice and, thus, be prevented from draining from the wall structure, at least until the exterior temperature increases. When that happens, however, the moisture can still cause significant damage to the wall structure.

Several products exist to allow drainage of moisture from wall structures once the moisture has formed in the wall structure.

U.S. Pat. No. 3,654,765, Healy et al, Subterranean Wall Drain, discloses a subterranean wall drain unit including a drain pipe having openings therein and a longitudinally extending planar core defining channels normal to the pipe. A water pervious sheet material covers one face of the core and the openings in the pipe to form a filter therefore.

The other face of the core may be covered with a plastic sheet or other vapor barrier.

U.S. Pat. No. 3,888,087, Bergsland, Foundation Wall Protective Sheet, discloses improvements in protective membranes or sheets for foundation walls. The sheets have regular courses of protrusions for spacing the sheet from the foundation wall and a porous backing for drainage outwardly of the sheet. The protrusions provide air channels between the protective sheet and the foundation for thermal insulation and for facilitating drying of the foundation wall. Small vertical ribs between the courses of the protrusions provide convenient water passages to take care of drainage water in the porous backing without interfering with the air spaces and incidentally providing bending vertical lines for more facile installation handling. Modifications of the sheet include transverse ribs at lower portions of the sheet to allow horizontal bending thereof wall for footing and drainage configurations. A barrier for preventing back fill falling between the protective sheathing and foundation is also disclosed.

U.S. Pat. No. 3,318,056, Thompson, Ventilating Wall Construction With Stud Location Indicators, discloses a sheet of building material placed between wall veneers for moisture protection that includes vertical drainage channels and perforations.

U.S. Pat. No. 6,298,620, Hatzinilolas, Moisture Control Panel, discloses a moisture control panel used in exterior walls. A wall constructed with the panel has an inner back-up wall component and an outer wall component of a moisture pervious material, for example, stucco. The moisture control panel is positioned between the two. It has a base sheet on the inner face of the outer wall component. A set of drying perforations slope downwardly toward the inside through this sheet. This drains moisture from the inside of the outer wall component. On the inside, the bay sheet has a set of upwardly sloping bosses which provide an air space on the inside the moisture control panel providing for air circulation and drainage of any moisture.

U.S. Pat. No. 4,381,630, Koester, Foundation Vent Structure, discloses a foundation vent structure positioned upon the footings of the building below the lowermost row of concrete blocks of the basement wall and extends below the concrete floor of the basement. The vent structure is formed of a plastic material, preferably in strips, and is shaped to define alternate tunnels and channels having openings therein. The vent structure intercommunicates the openings in the hollow, concrete blocks with the drain area located along the marginal area below the basement wall to permit moisture to be vented into this drain area.

U.S. Pat. No. 6,990,775, Koester, Moisture Drainage Product, discloses a product adapted to allow drainage of moisture from a wall structure. A sheet of corrugated material forms a plurality of square ridges and grooves on opposite sides of the sheet of material. The sheet of corrugated material is relatively inflexible under a force applied generally perpendicular to the sheet. The sheet of corrugated material has a multiplicity of perforations. A sheet of water permeable material is affixed to one side of the sheet of corrugated material. The product is flexible in a direction along the plurality of ridges and grooves allowing the product to be stocked in roll form. A method of providing drainage of moisture from a wall structure is also disclosed.

### SUMMARY

However, the greater the percentage of draining material that is in contact with the exterior wall, the less moisture is able to drain via the drainage portion of the system, as the portion that is in contact with the exterior wall allows moisture to form but not to drain from gravity. Furthermore, at least some of the products described above may not tend to be particularly robust in places where the product is penetrated, for instance, by a nail. In both cases, the efficiency of the product will decrease, thereby heightening the chances that moisture will remain in the walls and cause damage.

In an embodiment, a product is adapted to allow drainage of moisture from a wall of a structure. The product comprises a sheet of material having a multiplicity of perforations and having a plurality of ridges and grooves forming a bearing surface on one side of the product, the bearing surface being not greater than twenty percent of a surface area of the product. The product further comprises a sheet of permeable material affixed to the bearing surface on the one side of the sheet of material, the sheet of permeable material being permeable to water and water vapor.

In an embodiment, the plurality of ridges and grooves are parallel with respect to one another.

In an embodiment, the product is flexible in a direction along the plurality of ridges and grooves allowing the product to be stocked in roll form.

In an embodiment, the sheet of permeable material affixed to the one side of the sheet of material extends beyond the sheet of material a distance allowing the sheet of permeable material to be wrapped under an edge of the plurality of ridges.

In an embodiment, the plurality of ridges and grooves are formed with a plurality of generally linear walls are angled at an angle of at least twenty degrees from a direction orthogonal to the bearing surface of the product, individual ones of the plurality of generally linear walls being angled with respect to each other in an opposite direction with respect to the orthogonal surfaces; and to the surface of the sheet.

In an embodiment, the angle of an individual one of the generally linear walls is oriented in a first direction and the angle of another individual one of the generally linear walls is oriented in a second direction.

In an embodiment, the first direction is a direction oriented oppositely from the second direction.

In an embodiment, the first direction is a direction oriented generally orthogonal to the ridges and grooves.

In an embodiment, the plurality of ridges and grooves form an arcuate edge profile.

In an embodiment, the edge profile is approximately sinusoidal.

In an alternative embodiment, a product is adapted to allow drainage of moisture from a wall of a structure, the product having a horizontal length. The product comprises a sheet of material having a multiplicity of perforations and having a plurality of parallel ridges and grooves. The plurality of ridges and grooves comprise a plurality of bearing surfaces, each individual one of the plurality of bearing surfaces being parallel to each other individual one of the plurality of bearing surfaces, a plurality of connecting surfaces, each individual one of the plurality of connecting surfaces being parallel to each individual one of the bearing, and a plurality of angled surfaces, an individual one of the plurality of angled surfaces being adjacent to an individual one of the plurality of bearing surfaces and an individual one of the plurality of connecting surfaces, each individual one of the plurality of angled surfaces forming an obtuse angle with an adjacent one of the plurality of bearing surfaces. The plurality of bearing surfaces comprise not more than twenty percent of a surface area of the product. The product further comprises a sheet of material affixed to one side of the sheet of material, the sheet of material being permeable to water and water vapor.

In an embodiment, the obtuse angle is approximately one hundred and thirty-five degrees.

In an embodiment, the plurality of ridges and grooves are parallel.

In an embodiment, the plurality of ridges and grooves are evenly spaced.

In an embodiment, the sheet of water permeable material comprises polypropylene.

In an embodiment, the polypropylene comprises a spunbond polypropylene.

In an embodiment, the sheet of water permeable material comprises a fabric.

In an alternative embodiment, the present disclosure provides a wall system for a structure having an interior and an exterior. The system comprises a structural member forming a structural support for the wall system, sheathing placed exterior of the structural member, and a moisture drainage product adapted to allow drainage of moisture from the wall system. The moisture drainage product comprises a sheet of material having a multiplicity of perforations and having a plurality of ridges and grooves forming a bearing surface on one side of the product, the bearing surface being not greater than twenty percent of a surface area of the product, and a sheet of permeable material affixed to the bearing surface on the one side of the sheet of material, the sheet of permeable material being permeable to water and water vapor. The moisture drainage product is placed exterior of the sheathing with the ridges and grooves being oriented in a generally vertical direction with the sheet of permeable material facing the exterior, and an exterior veneer is placed exterior of the moisture drainage product.

In an embodiment, the plurality of ridges and grooves are formed with a plurality of generally linear walls are angled at an angle of at least twenty degrees from a direction orthogonal to the bearing surface of the product, individual ones of the plurality of generally linear walls being angled with respect to each other in an opposite direction with respect to the orthogonal to the surface of the sheet.

In an alternative embodiment, a method provides drainage of moisture from a wall of a structure, the wall having a structural member and an exterior veneer. A moisture drainage product is applied to the exterior of the structural member. The moisture drainage product has a sheet of material having a multiplicity of perforations and having a plurality of ridges and grooves forming a bearing surface on one side of the product, the bearing surface being not greater than twenty percent of a surface area of the product, and a sheet of permeable material affixed to the bearing surface on the one side of the sheet of material, the sheet of permeable material being permeable to water and water vapor. The applying a moisture drainage product step is accomplished with the ridges and grooves being oriented in a generally vertical direction with the sheet of water permeable material facing away from the structural member.

In an embodiment, the step of applying a veneer exterior of the moisture drainage product is accomplished with the ridges and grooves maintaining an ability to channel to channel moisture along the ridges and grooves.

### BRIEF DESCRIPTION OF THE DRAWINGS

FIG. 1 is a plan view of an embodiment of a moisture drainage product;

FIG. 2 is a edge view of the moisture drainage product illustrated in FIG. 1;

FIG. 3 is a close-up view a portion of the moisture drainage product illustrated in FIG. 1;

FIG. 4 is a partial cut-away perspective view of a wall structure incorporating the moisture drainage product illustrated in FIG. 1;

FIG. 5 is a perspective view showing the partial installation of the moisture drainage product illustrated in FIG. 1 installed over sheathing in a wall structure;

FIG. 6 is a perspective view showing the partial installation of the moisture drainage product illustrated in FIG. 1 in a wall structure with lathe installed over the moisture drainage product;

FIG. 7 is a perspective view showing the partial installation of the moisture drainage product illustrated in FIG. 1 in a wall structure with stucco installed over the lather and the moisture drainage product;

FIG. 8 is an edge view of an alternative embodiment of a sheet material for use in a moisture drainage product;

FIG. 9 is a plan view of the sheet material illustrated in FIG. 8;

FIG. 10 is an edge view of another alternative embodiment of a sheet material for use in a moisture drainage product.

### DETAILED DESCRIPTION

The contents of provisional U.S. application Ser. No. 60/912,530, filed Apr. 18, 2007, is hereby incorporated by reference in its entirety.

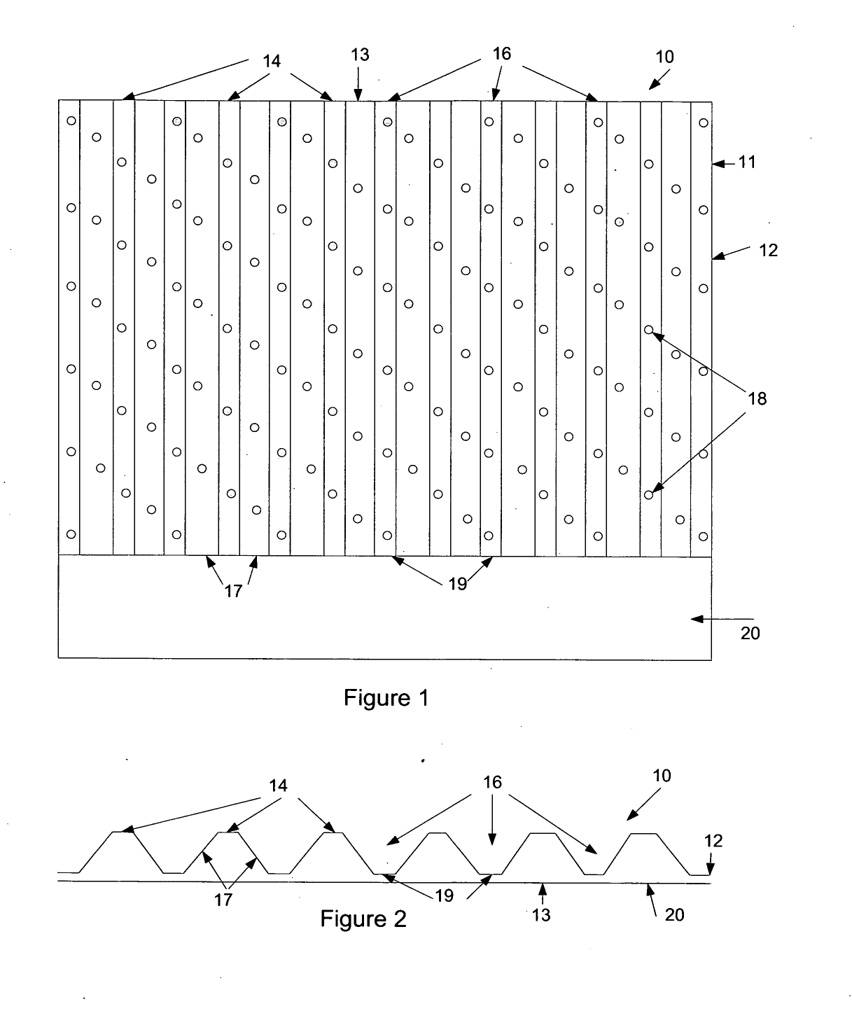

Since the presence of moisture in wall structures of buildings is not uncommon, it is desirable to drain such moisture from the wall structure. FIG. 1 and FIG. 2 illustrate a section of an embodiment of moisture drainage product 10. A sheet of material 12 is formed from a sheet of plastic material which has been heated and passed through a crimping apparatus producing a series of linear ridges 14 and grooves 16 approximately 0.488 inches (1.24 centimeters) deep and approximately 0.781 inches (1.98 centimeters) on center. Having been crimped, the sheet 12 forms a product 10 with a surface area defined by its height 11 multiplied by its width 13. The surface area of moisture drainage product 10 is determined by the planar surface area of the product and not by measuring the actual surface area of all of the ridges and grooves of sheet of material 12. In an embodiment, height 11 is approximately fifteen and three-quarter inches (40.005 centimeters). In a further embodiment, product 10 is produced and shipped with width 13 being twenty-five feet (7.62 meters). A user may then cut product 10 to reduce the width for use.

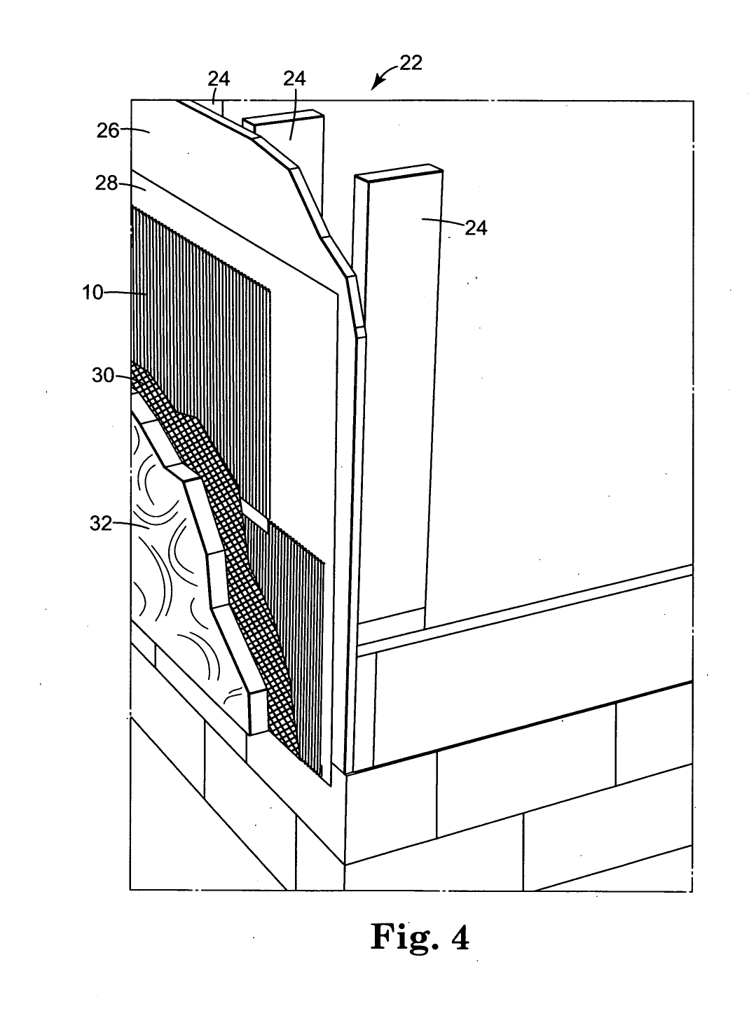

The vertical components of ridges 14 and grooves 16 are formed by angled walls 17. In addition, one surface of the sheet 12 becomes bearing surface 19 adapted to be in contact with exterior wall 23 of a wall structure 22 (FIG. 4). The combined surface area of all of the bearing surfaces 19 account for not more than twenty percent (20%) of the surface area of product 10. Minimizing the amount of product 10 in contact with exterior wall 23 maximizes the amount of water that may be drained away, as a surface in contact with exterior wall 23 may not be capable of conducting water.

In various embodiments, material 12 may be constructed from foils, such as copper, stainless steel and aluminum, plastics, and cellulose materials with a moisture resistant additive. In further embodiments, material 12 may be constructed from a high-impact polystyrene. The polystyrene may either be newly manufactured or from “green” post-industrial recycled materials.

As will be discussed with respect to later Figures, linear ridges 14 and grooves 16 of material 12 form a plurality of channels which, when moisture drainage product 10 is installed in a wall structure with ridges 14 and grooves 16 oriented in a generally vertical orientation, allows moisture which has accumulated in the wall structure to drain, via gravity, from the wall structure.

Material 12 also has a multiplicity of perforations 18 which may be formed in material 12 either before crimping or after crimping, although in one embodiment, before crimping is preferred. Perforations 18 in material 12 allow moisture, including water and water vapor, to pass through product 10 via perforations 18. Perforations 18 allow water vapor which has not condensed in the wall structure to continue to pass outwardly through the wall structure. Further, vertically oriented ridges 14 and/or grooves 16 allow water, e.g., condensed water vapor, to be drained by gravity from the wall structure.

A sheet of material 20 is affixed to one side of material 12. As shown in FIG. 1 and FIG. 2, sheet of material 20 is affixed to the back side of material 12. The primary function of sheet of material 20 is to prevent building materials from accumulating in ridges 14 or grooves 16 on the side of material 12 having sheet of material 20. If building materials, in the course of construction, were allowed to accumulate in such ridges 14 and grooves 16, the channels formed by ridges 14 and grooves 16 could be obstructed by the building material and the drainage ability of the channels formed by ridges 14 and grooves 16 could be impeded or blocked. Sheet of material 20 may be pervious to moisture, including water and water vapor.

In an embodiment, sheet of material 20 is constructed of polypropylene, such as spunbond polypropylene. Alternatively, sheet of material could be constructed of a fabric woven of a moisture resistant material. Sheet of material 20 may be affixed to material 12 in any suitable manner such as by commonly available commercial construction adhesives. In a further embodiment, sheet of material 20 may extend beyond material 12, such that the portion of sheet of material 20 that extends beyond material 12 may be folded so as to prevent access to ridges 14 and grooves 16 from the bottom of product 10 by insects and bugs after product 10 has been installed (FIGS. 4-7). In an embodiment, sheet of material 20 extends four inches beyond the end of material 12.

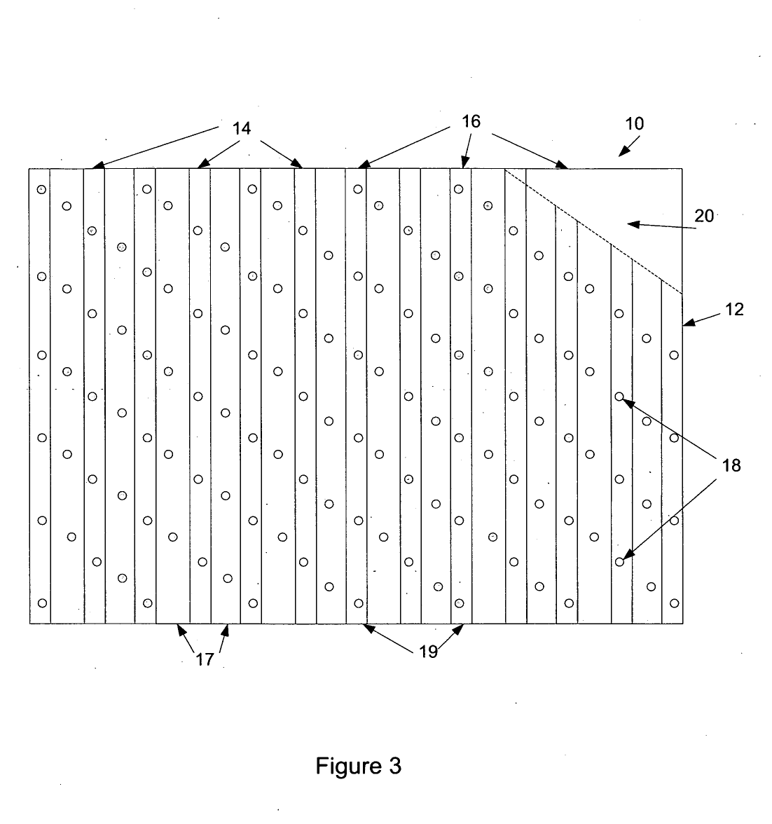

FIG. 3 is a close-up view of a portion of moisture drainage product 10 showing material 12 including ridges 14 and grooves 16, formed by angled surfaces 17 and bearing surfaces 19, forming channels, perforations 18 and sheet of material 20.

Material 12 is constructed of a material which is rigid enough such that, when corrugated with ridges 14 and grooves 16, is able to withstand commonly encountered construction forces as moisture drainage material 10 is being installed in a wall structure. Examples of commonly encountered construction forces are hammer or automated nailing strikes either affixing moisture drainage product 10 in the wall structure or affixing a later applied material in the wall structure such as the exterior veneer. As an example, an exterior veneer of stucco typically requires a lathe material to be applied exterior to moisture drainage product 10. The force required by nails or spikes to secure the lathe material to the wall structure should not compromise ridges 14 and grooves 16 to the extent that drainage channels formed by ridges 14 and grooves 16 are obstructed. Similarly, commonly encountered forces involved in shipping, storing and handling of moisture drainage product 10 should also not compromise the drainage channels. In a preferred embodiment, moisture drainage product 10 is able to withstand the weight of a typical construction worker wearing shoes.

It will be appreciated that ridges 14 and grooves 16 of moisture drainage product 10 increase the rigidity of moisture drainage product as moisture drainage product 10 is attempted to be bent transverse to ridges 14 and grooves 16. Thus, ridges 14 and grooves 16 actually increase the rigidity of moisture drainage product 10 and help allow moisture drainage product 10 to withstand normal construction forces. It will also be appreciated that ridges 14 and grooves 16 in moisture drainage product 10 allow moisture drainage product 10 to be less rigid in a direction parallel to ridges 14 and grooves 16. This relatively less rigidity allows moisture drainage product 10 to be shipped, stocked and stored as a roll stock. Preferably, moisture drainage product 10 can be shipped and stored on 25 foot (7.62 meter) rolls. Alternatively, moisture drainage product 10 can be shipped and stored on 50 foot (15.2 meter) rolls. Alternatively, moisture drainage product could also be shipped, stocked and stored as rigid sheet stock.

FIG. 4 is an illustration of wall structure 22 containing moisture drainage product 10. Starting at the interior side of wall structure 22, conventional studs 24 form a plane along which sheathing 26 may be affixed. Typically, and optionally, a water barrier 28, such as #15 roll stock, is applied exterior to sheathing 26. Moisture drainage product 10 is affixed exterior to water barrier 28 with sheet of material 20 facing outwardly. Sheet of material 20 extends beyond material 12 on one edge of the roll of moisture drainage product 10. This edge of sheet of material 20 is used to overlap the next roll of moisture drainage product 10. The lowest roll of moisture drainage product 10 in wall structure 22 has this edge of sheet of material 20 wrapped under material 12 to form a bug screen. A veneer for wall structure 22 is applied to form exterior wall 23 exterior to moisture drainage product 10. In one embodiment, the veneer consists of a metal lathe 30 and stucco 32 applied over metal lathe 30. It is to be recognized and understood that many other forms of exterior veneer are also contemplated including, but not limited to concrete block, brick, natural or man-made stone, and wood siding of all types including wooden lap siding.

It can be recognized that without moisture drainage product 10 in wall structure 22 that moisture occurring or accumulating in wall structure 22 can drain through channels created by ridges 14 and grooves 16 in moisture drainage product. Perforations 18 allow moisture drainage product 10 to be water pervious allowing water and water vapor to pass through moisture drainage product 10. This prevents moisture drainage product from a vapor barrier in the middle of wall construction 22 and actually causing the moisture accumulation it is designed to ameliorate. Further, sheet of material 20 prevents the stucco material 32 from obscuring channels formed in material 12 on the exterior side of moisture drainage product 10.

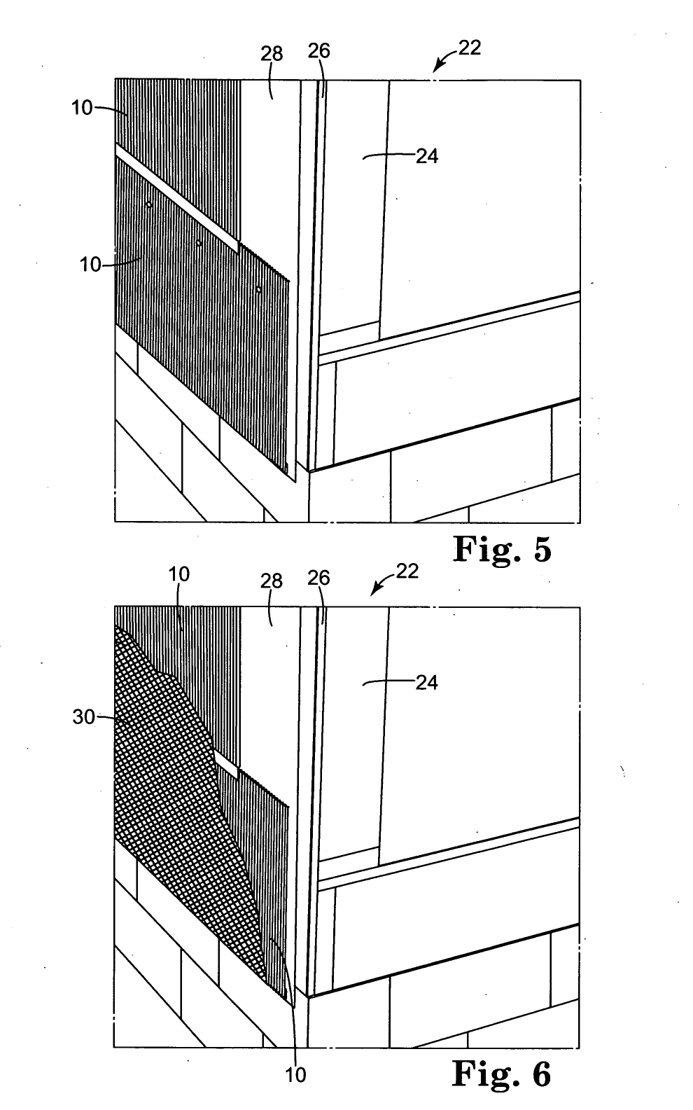

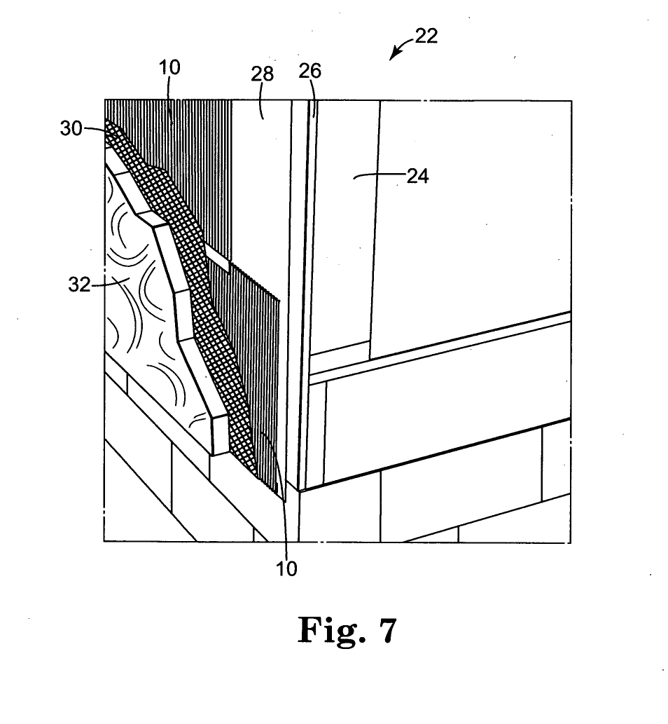

FIG. 5, FIG. 6 and FIG. 7 illustrate a method of constructing wall structure 22.

In FIG. 5, wall structure 22 is partially formed with studs 24, sheathing 26 and roll stock 28. This is a typical and conventional wall structure construction technique. Typically, studs 24 are installed and then sheathing 26 is affixed to the exterior side of studs 24. Roll stock 28 is then affixed to the exterior side of sheathing 26. Studs 24, sheathing 26 and, optionally, roll stock 28 form the structural components of wall structure 22. Of course, it is recognized and understood that wooden studs 24, sheathing 26 and roll stock 28 are just one example of what could comprise the structural components of wall structure 22. Many other conventional, and unconventional, products, materials and construction could also used. As can be seen in FIG. 5, moisture drainage product 10 is then conventionally affixed with construction fasteners exterior to roll stock 28 and sheathing 26. Note that sheet of material 20 is again placed on the exterior side of moisture drainage product 10. Thus, FIG. 5 shows wall structure 22 in a partially completed state with moisture drainage product 10 installed but without an exterior veneer.

In FIG. 6, the construction of wall structure 22 has taken one more step, the step of partially completing the exterior veneer. In this embodiment, the exterior veneer is stucco. In order to prepare wall structure 22 for stucco material 32, lathe, preferably metal lathe, 30 is conventionally affixed exterior of moisture drainage product 10. In FIG. 7, stucco 32 can be seen having been applied to lathe 30. Again, especially since stucco material 32 is semi-liquid when applied to lathe 30 and is intermixed with lathe 30 to give stucco structural integrity, that it is likely that stucco 32 would get into the channels formed by ridges 14 and grooves 16 of material 12 if it were not for sheet of material 20 which effectively prevents the clogging of the channels formed by ridges 14 and grooves 16.

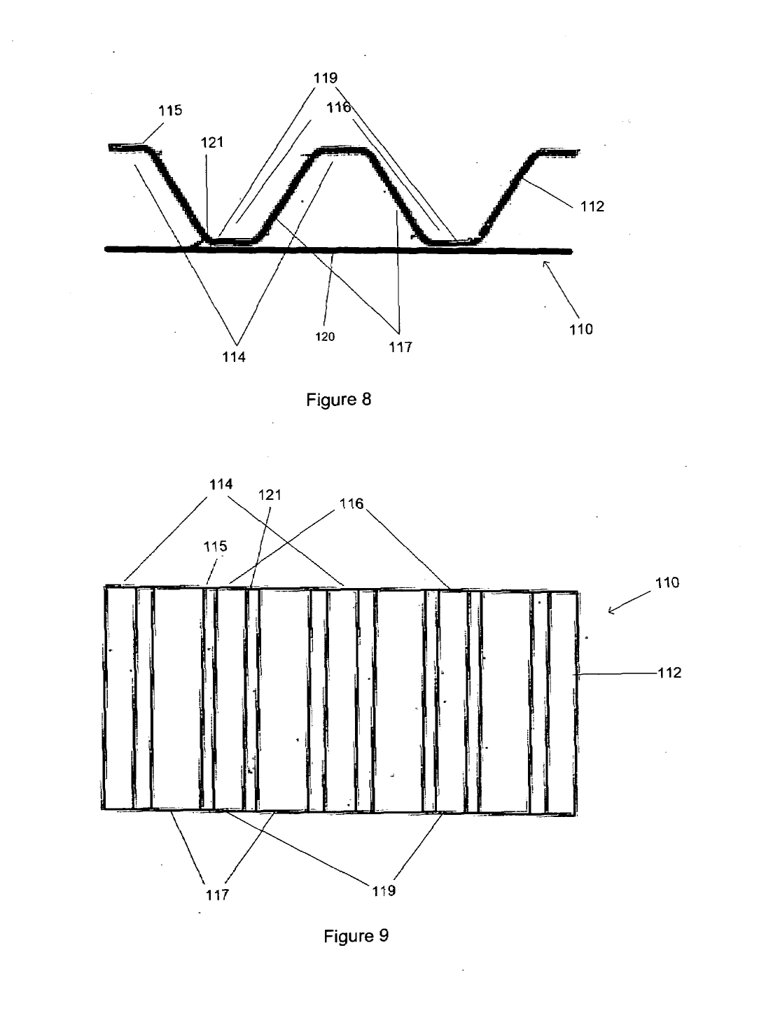

FIG. 8 and FIG. 9 illustrate an alternative embodiment of moisture drainage product 110. Sheet of material 112 may be comprised of the same materials which may comprise sheet of material 12, and may be approximately 0.020 inches thick. Ridges 114 and grooves 116 may be approximately 0.125 inches wide. Angled walls 117 may be oppositely angled approximately sixty (60) degrees with respect to each other. Radii 115 connecting groove 116 and one angled wall 117 may have an arc of approximately 0.080 inches while radii 121 connecting groove 116 and an oppositely angled wall 117 may have an arc of approximately 0.060 inches. In an embodiment, sheet of material 112 may contain a multiplicity of perforations such as perforations 18 as implemented with respect to sheet of material 12 in FIGS. 1 through 3.

Ridges 114 form the bearing surface of moisture drainage product 110. It is the surface of ridges 114 that bears against sheet of material 120 and ultimately against another member of the wall structure. The lateral distance of the surface area of moisture drainage product 110 that does not form a bearing surface, i.e., does not directly bear upon sheet of material 120 or upon an adjoining member of the wall structure may be approximately 0.781 inches. Thus, ridges 114 may form a bearing surface having approximately fourteen percent (14%) of the entire surface area of moisture drainage product 110. Sheet of material 112 may have an overall thickness of approximately 0.448 inches between bearing surfaces.

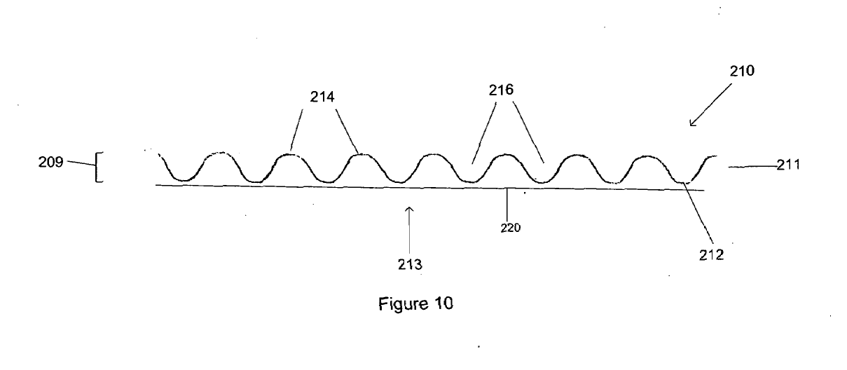

FIG. 10 illustrates an edge profile of an alternative embodiment of moisture drainage product 210, with sheet of material 212 having an approximately sinusoidal arcuate edge profile. The sinusoidal profile has a plurality of ridges 214 and troughs 216 which may create a bearing surface comprising a reduced percentage of the entire surface area of moisture draining product 210 relative to the embodiments of FIGS. 1 through 3 and FIGS. 8 and 9. The bearing surface may abut sheet of material 220, which may be the same composition as sheet of material 20. In an embodiment, the area of the bearing surface may be less than five percent (5%) of the entire surface area of moisture drainage product 210. In an embodiment, thickness 209 of material 212 is approximately ten millimeters, height 211 of material 212 is approximately 31.5 inches (80.01 centimeters), and width 213 is approximately twenty-five feet (7.62 meters).

Thus, embodiments of the moisture drainage product having limited bearing surface, wall system incorporating such and method therefore are disclosed. One skilled in the art will appreciate that the present invention can be practiced with embodiments other than those disclosed. The disclosed embodiments are presented for purposes of illustration and not limitation, and the present invention is limited only by the claims that follow.

What is claimed is:

1. A product adapted to allow drainage of moisture from a wall of a structure, comprising:
a sheet of material having a multiplicity of perforations and having a plurality of ridges and grooves forming a bearing surface on one side of said product, said bearing surface being not greater than twenty percent of a surface area of said product; and
a sheet of permeable material affixed to said bearing surface on said one side of said sheet of material, said sheet of permeable material being permeable to water and water vapor.

2. The product as in claim 1 wherein said plurality of ridges and grooves are parallel with respect to one another.

3. The product as in claim 2 wherein said product is flexible in a direction along said plurality of ridges and grooves allowing said product to be stocked in roll form.

4. The product as in claim 2 wherein said sheet of permeable material affixed to said one side of said sheet of material extends beyond said sheet of material a distance allowing said sheet of permeable material to be wrapped under an edge of said plurality of ridges.

5. The product as in claim 1 wherein said plurality of ridges and grooves are formed with a plurality of generally linear walls angled at an angle of at least twenty degrees from a direction orthogonal to said bearing surface of said product, individual ones of said plurality of generally linear walls being angled with respect to each other in an opposite direction with respect to said direction.

6. The product as in claim 5 wherein said angle of an individual one of said generally linear walls is oriented in a first direction and said angle of another individual one of said generally linear walls is oriented in a second direction.

7. The product as in claim 6 wherein said first direction is a direction oriented oppositely from said second direction.

8. The product as in claim 7 wherein said first direction is a direction oriented generally orthogonal to said ridges and grooves.

9. The product as in claim 1 wherein said plurality of ridges and grooves form an arcuate edge profile.

10. The product as in claim 9 wherein said edge profile is approximately sinusoidal.

11. A product adapted to allow drainage of moisture from a wall of a structure, comprising:
a sheet of material having a multiplicity of perforations and having a plurality of parallel ridges and grooves, said plurality of ridges and grooves comprising:
a plurality of bearing surfaces, each individual one of said plurality of bearing surfaces being parallel to each other individual one of said plurality of bearing surfaces;
a plurality of connecting surfaces, each individual one of said plurality of connecting surfaces being parallel to each individual one of said bearing surfaces;
a plurality of angled surfaces, an individual one of said plurality of angled surfaces being adjacent to an individual one of said plurality of bearing surfaces and an individual one of said plurality of connecting surfaces, each individual one of said plurality of angled surfaces forming an obtuse angle with an adjacent one of said plurality of bearing surfaces;
wherein said plurality of bearing surfaces comprise not more than twenty percent of a surface area of said product; and
a sheet of material affixed to one side of said sheet of material, said sheet of material being permeable to water and water vapor.

12. The product of claim 11 wherein said obtuse angle is approximately one hundred and thirty-five degrees.

13. The product as in number 11 wherein said plurality of ridges and grooves are parallel.

14. The product as in number 11 wherein said plurality of ridges and grooves are evenly spaced.

15. The product as in number 11 wherein said sheet of water permeable material comprises polypropylene.

16. The product as in number 15 wherein said polypropylene comprises a spunbond polypropylene.

17. A product as in number 11 wherein said sheet of water permeable material comprises a fabric.

18. A wall system for a structure having an interior and an exterior, comprising:
a structural member forming a structural support for said wall system;
sheathing placed exterior of said structural member;
a moisture drainage product adapted to allow drainage of moisture from said wall system, comprising:
a sheet of material having a multiplicity of perforations and having a plurality of ridges and grooves forming a bearing surface on one side of said product, said bearing surface being not greater than twenty percent of a surface area of said product; and
a sheet of permeable material affixed to said bearing surface on said one side of said sheet of material, said sheet of permeable material being permeable to water and water vapor;
said moisture drainage product being placed exterior of said sheathing with said ridges and grooves being oriented in a generally vertical direction with said sheet of permeable material facing said exterior; and
an exterior veneer placed exterior of said moisture drainage product.

19. The wall system as in number 18 wherein said plurality of ridges and grooves are formed with a plurality of generally linear walls are angled at an angle of at least twenty degrees from a direction orthogonal to said bearing surface of said product, individual ones of said plurality of generally linear walls being angled with respect to each other in an opposite direction with respect to said surface of said sheet.

20. The wall system as in number 19 wherein said angle of an individual one of said generally linear walls is oriented in a first direction and said angle of another individual one of said generally linear walls is oriented in a second direction.

21. The wall system as in number 20 wherein said first direction is a direction oriented oppositely from said second direction.

22. The wall system as in number 21 wherein said first direction is a direction oriented generally orthogonal to said ridges and grooves.

23. The wall system as in number 18 wherein said plurality of ridges and grooves are parallel.

24. The wall system as in number 23 wherein said plurality of ridges and grooves are evenly spaced.

25. A method of providing drainage of moisture from a wall of a structure, said wall having a structural member and an exterior veneer, comprising the steps of:
applying a moisture drainage product to the exterior of said structural member, said moisture drainage product comprising:
a sheet of material having a multiplicity of perforations and having a plurality of ridges and grooves forming a bearing surface on one side of said product, said bearing surface being not greater than twenty percent of a surface area of said product; and
a sheet of permeable material affixed to said bearing surface on said one side of said sheet of material, said sheet of permeable material being permeable to water and water vapor;
said applying a moisture drainage product step being accomplished with said ridges and grooves being oriented in a generally vertical direction with said sheet of water permeable material facing away from said structural member; and
applying a veneer exterior of said moisture drainage product.

26. A method as in number 25 wherein said step of applying a veneer exterior of said moisture drainage product is accomplished with said ridges and grooves maintaining an ability to channel to channel moisture along said ridges and grooves.
